(19) United States
(12) Patent Application Publication
(10) Pub. No.: US 2009/0161874 A1
(43) Pub. Date: Jun. 25, 2009

(54) Key Management Method for Security and Device for Controlling Security Channel In Epon

(76) Inventors: Jee Sook Eun, Chunlabook-do (KR); Yool Kwon, Busan (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/083,332

(22) PCT Filed: Dec. 5, 2006
(86) PCT No.: PCT/KR2006/005212

§ 371 Date: Apr. 7, 2008

(30) Foreign Application Priority Data
Dec. 7, 2005 (KR) 10-2005-0118804
Jul. 4, 2006 (KR) 10-2006-0062680

(51) Int. Cl. H04L 9/28; H04L 9/00

(52) U.S. Cl. 380/277

(57) ABSTRACT

A key management method for encrypting a frame in an Ethernet passive optical network (EPON) is provided. In the method, secure parameters including secure keys and their association numbers which are used in the present or will be used in the next by each secure channel are managed by composing a key information table. Then, it determines whether an association number of a received encryption frame is valid or not with reference to the key information table if the encryption frame of which association number has been changed is received. A secure key changes if the association number is determined to be valid, and the secure key does not change if the association number is not valid.

### TECHNICAL FIELD

The present invention relates to a key management method for encrypting a frame in an Ethernet passive optical network (EPON), more particularly, to a key management method and a security channel control apparatus for providing a secure service for an EPON to prevent a key reuse attack.

### BACKGROUND ART

An Ethernet passive optical network (EPON) includes an optical line terminal (OLT) 11 and a plurality of optical network units (ONUs) 12, as shown in FIG. 1. The OLT 11 is connected to an external network, for example, an Internet protocol (IP) network, an asynchronous transfer mode (ATM) network, a public switched telephone network (PSTN) and so on. The ONU 12 is connected to a user terminal. The OLT 11 and the ONU 12 are connected to each other through an optical fiber. The EPON is a passive optical network to connect the user terminals to the IP network, ATM network, PSTN, and etc.

In order to provide a security function and an authentication function for frames transmitted and received between the OLT 11 and the ONUs 12 in the EPON, the standardization of the schemes and structures of MAC security in a data link layer is in progress by IEEE 802.

The security technology is divided into an encryption technique for encrypting frames and a key management technique for managing parameters necessary to encrypt frames. The related specification and plans for the frame encryption technique have been discussed in IEEE 802.1ae. Also, the related specifications and plans for the key management technique have been discussed in IEEE 802.1af.

Referring to FIG. 2, the MAC secure frame introduced by IEEE 802.1ae includes a MAC address having a destination address denoting a destination to transmit a corresponding frame and a source address denotes a source transmit a corresponding frame, and user data like as a typical Ethernet frame. Unlike the typical Ethernet frame, the user data of the MAC secure frame is encrypted to a secure data using an encryption suit, a security tag secTAG is inserted between the MAC address for transferring parameters for encryption, and an integrity check value ICV is inserted at the back of the secure data for checking integrity of a corresponding frame.

The secure data is encoded by a predetermined encryption algorithm using a secure key and an initialization vector. Herein, the encryption parameters including the secure key and the upper bit values of the initialization vector are shared between a transmitting side and a receiving side through a key distribution algorithm. The other bit values of the initialization vector are configured as packet numbers defined in a secure tag of the MAC secure frame. Therefore, only authenticated receiving sides can decode a corresponding secure data using the packet number of the receiving frame and the shared the secure key and upper bit value of the initialization vector.

A security cannot be guaranteed when frames having the same packet number (PN) are encrypted with the same secure key in an EPON that uses a data link layer encryption algorithm, GCM-AES (Galois/Counter Mode of Operation-Advanced Encryption Standard) defined by IEEE 802.1ae. Therefore, if available packet numbers are exhausted, a new secure key is generated and distributed. Also, a security channel introduced by IEEE 802.1ae is identified by an association number (AN). The association number (AN) is formed of two bits and has a value from 0 to 3. That is, each of four security associations in one secure connectivity is discriminated from others by the association number. If the association number changes, the secure key (SAK) also changes. Therefore, the secure key (SAK) is set differently according to the AN, and the secure key (SAK) changes after the valid date of using the secure key (SAK) has expired.

A receiving side inspects an association number (AN) and a packet number PN in a secure tag of a received frame using such parameters, and senses a Denial of Service (DoS) attack. Relatively, IEEE 802.1ae introduced a method of sensing a key reuse attack if the PN of a received encoded frame is smaller than or equal to the PN of a previous encrypted frame received with the same AN. IEEE 802.1af also introduces a method of managing the life time of key after the key is generated by checking the life time of a key using a reference value for key update after key distribution, thereby preventing data delay attack.

However, it is difficult to sense a DoS attack made when a frame with an intentionally modified AN is transmitted.

As shown in FIG. 3, if a receiving side receives an encrypted frames F5 to F8 having AN of 3 while receiving encrypted frames F1 to F4 with AN of 2 at step S11, the receiving side decodes the received frame using a secure key corresponding to the AN of 3 by sensing the used secure key (SAK) changed.

If the frames F5 to F8 are the DoS attack using a frame previously passing a secure channel, the secure key becomes unmatched. Therefore, the decoding of the frames F5 to F8 is failed at step S12. Also, since a secure key changes at a time of receiving a frame with the AN of 3, the receiving side fails to decode at step S14 although the receiving side receives the normal frames F9 to F12 with AN of 2 at step S12 because the secure key change to another value already.

### DISCLOSURE OF INVENTION

### Technical Problem

An aspect of the present invention is to provide a key management method for providing a security service in an EPON for guaranteeing normal operation of a receiving side by accurately blocking a frame with an association number changed intentionally when a security key change is sensed through the changes of the association number of security association, and an EPON secure channel control apparatus using the same.

Another aspect of the present invention is to provide a key management method for providing a security service in an EPON for guaranteeing the normal operation of a receiving side by accurately controlling a time of distributing a key in a key management module and a time of transferring a distributed key to an encryption module, and an EPON secure channel control apparatus.

### Technical Solution

According to an aspect of the invention, the invention provides a key management method for providing a security service for an Ethernet passive optical network (EPON), the method including: managing secure parameters including secure keys and their association numbers which are used in the present or will be used in the next by each secure channel by composing a key information table; determining whether an association number of a received encryption frame is valid or not with reference to the key information table if the encryption frame of which association number has been changed is received; and changing a secure key if the association number is determined to be valid, and not changing a secure key if the association number is not valid.

The key information table may include a field to write distributed secure key values, a field to write an initialization vector (IV) value used for an encryption algorithm corresponding to the secure key, a field to indicate an association number by which the secure key is used, and a state field to indicate whether the secure key is used in the present or will be used in the next.

In the step of managing secure parameters, an association number, and an initialization vector of the new secure key may be written, and a state value may be denoted as a current key to be used in the present in the state field if a new secure key is distributed in an initial state, and a key value, an association number, and an initialization vector of the new secure key may be written, and a state value may be denoted as a next key to be used in the next in the state field if a new secure key is distributed during an encryption service.

In the step of managing secure parameters, if a packet number available for the secure key is exhausted, or a normal encryption frame of which association number has been changed is received, an entry for which the state value has been denoted as the current key may be deleted from the key information table, and a state value of an entry corresponding to the next key may be changed into a current key.

In the step of determining whether an association number of a received encryption frame is valid or not, after an association number written in a secure tag of a received encryption frame is compared with an association number written as a parameter which will be used in the next in the key information table, the received encryption frame may be determined to be valid if the two association numbers are identical to each other, otherwise, the received encryption frame is determined to be invalid if the two association numbers are not identical to each other.

After checking whether a packet number used in the secure key reaches a threshold value, the secure key may be distributed when the packet number reaches the threshold value.

A transmitting side may check whether the packet number reaches the threshold value.

The distribution of the secure key may be performed at an interval calculated in proportion to a link transfer rate and a frame size.

According to another aspect of the invention, the invention provides an apparatus for controlling a security channel in an EPON including: a key management module for distributing a secure key used for a secure channel, composing a key information table, managing parameter information including the distributed secure key and its association number of each of the secure channel and a use state to indicate whether the corresponding parameter is used in the present or will be used in the next, and controlling a change in the secure key by determining whether an association number of a received frame is valid or not with reference to the key information table, if the association number of the received frame has been changed; and an encryption module for encrypting/decrypting a transmitted/receive frame using a key provided from the key management module.

The key information table includes a field to write distributed secure key values, a field to write an initialization vector (IV) value used for an encryption algorithm corresponding to the secure key, a field to indicate an association number by which the secure key is used, and a state field to indicate whether the secure key is used in the present or will be used in the next. The key management module may write a key value, an association number, and an initialization vector of the new secure key and denote a state value as a current key to be used in the present in the state field if a new secure key is distributed in an initial state, and the key management module may write a key value, an association number, and an initialization vector of the new secure key and denote a state value as a next key to be used in the next in the state field if a new secure key is distributed during an encryption service. If a packet number available for the secure key is exhausted, or a normal encryption frame of which association number has been changed is received, the key management module deletes an entry for which the state value has been denoted as the current key from the key information table and changes a state value of an entry corresponding to the next key into a current key.

After comparing an association number written in a secure tag of a received encryption frame with an association number written as a parameter which will be used in the next in the key information table, the key management module determines the received encryption frame to be valid if the two association numbers are identical to each other, and the key management module determines the received encryption frame to be invalid if the two association numbers are not identical to each other.

After receiving information indicating whether a packet number used in the secure key reaches a threshold value, the key management module may make a decision of time to distribute a secure key based on the information. The decision of time to distribute the secure key may be made by a transmitting side for the secure channel. The threshold value may be set so as to transfer a newly distributed secure key and its parameter before a packet number is completely exhausted taking time to spend to transfer the distributed secure key and the parameter from the key management module to the encryption module into consideration.

It is preferable that a transmitting side further accurately manage packet numbers because the decision of time to distribute a secure key is made without frame loss.

### ADVANTAGEOUS EFFECTS

According to the certain embodiment of the present invention, a stable operation of a receiving side can be guaranteed by effective detecting a DoS attack which is generated when a change of secure key is recognized identically to a change of a corresponding association number (AN) for security.

Furthermore, since a receiving side can sense an attacking frame with an association number changed without decoding a received frame at the receiving side, the load of the receiving side can be reduced by shortening a time and a processing capacity wasted for sensing a DoS attack and drives a stable operation.

### BRIEF DESCRIPTION OF THE DRAWINGS

FIG. 1 is a block diagram illustrating an Ethernet passive optical communication network;

FIG. 2 is a diagram illustrating a structure of a MAC secure frame introduced by IEEE 802.1ae;

FIG. 3 is a flowchart illustrating a key management method according to an embodiment of the present invention;

FIG. 4 is a flowchart illustrating failure when a conventional DoS attack frame is received;

FIG. 5 is a diagram illustrating an operating state when a DoS attach frame is received in an embodiment of the present invention; and

FIG. 6 is a block diagram illustrating a secure module of an Ethernet passive optical network according to an embodiment of the present invention.

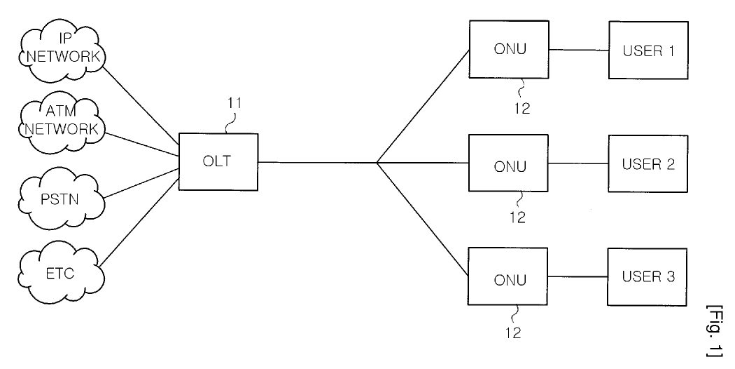

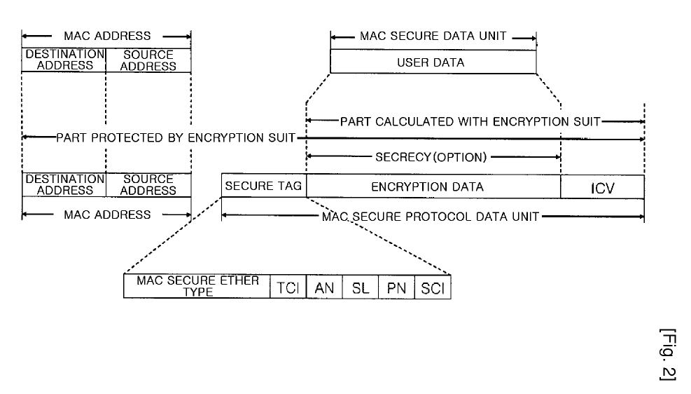

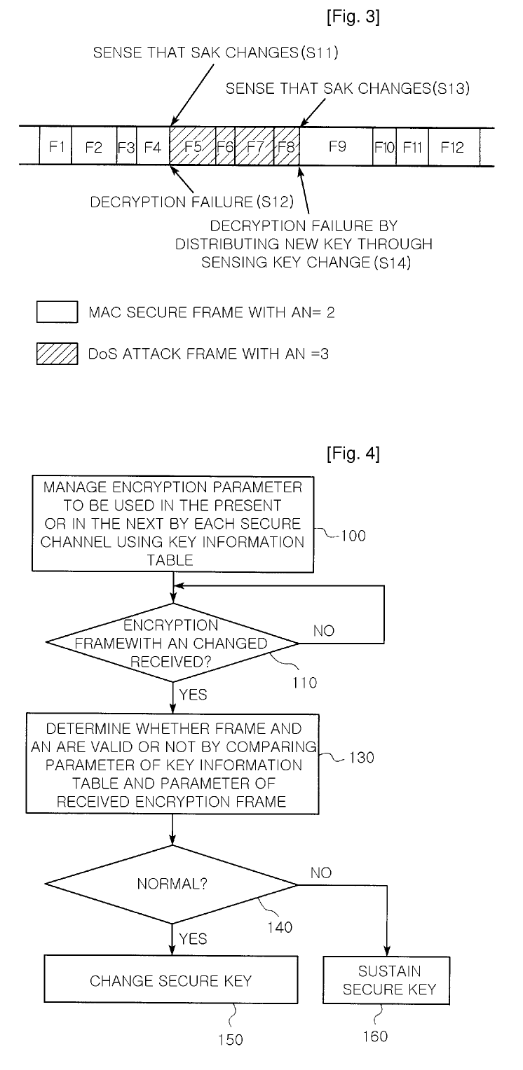

### BEST MODE FOR CARRYING OUT THE INVENTION

Hereinafter, preferred embodiments of the present invention will be described in detail with reference to the attached drawings.

A key management method for providing a security service for an EPON according to an exemplary embodiment of the present invention will now be described in detail. Throughout this specification, like reference numerals designate like elements.

In the following description, a secure key will be generally used for an encryption key and a decryption key.

An EPON system according to certain embodiments of the present invention, in which a change in an association number (AN) of a secure association (SA) and a change in a secure key (SAK) are recognized to be equal, uses key information tables for managing information of distributed secure keys to resend a frame transmitted from a previous security channel, to detect an attack of changing and transmitting the association number (AN) of the frame transmitted from the previous security channel, and to make sure whether all parameters for an association number (AN) to be changed have been transferred from a key management module to a encryption module.

FIG. 4 is a flowchart showing a key management method for providing a security service in an EPON according to an exemplary embodiment of the present invention.

To provide a security service in accordance with IEEE 802.1ae and IEEE 802.1af, the system according to the present embodiment makes a key information table for each secure channel and manages a current encryption parameter which is used in the present and a next encryption parameter which will be used in the next for a secure channel, at step S110. More specifically, the key information table is used for managing a current secure key and its association number that are used in the present and a next secure key and its association number that will be used in the next. It is preferable that each entry in the key information table includes a key field to write a distributed secure key value, an initialization vector (IV) field to write an initialization vector (IV) value, an association number (AN) field to indicate an association number (AN) used for the secure key, and a state field to show whether the secure key is used in the present or will be used in the next. Each of the fields in the key information table is initialized to a null before setting.

The following Table 1 shows an example of a key information table in a initial state.

TABLE 1

| | Initialization Vector | Association Number | |
|---|---|---|---|
| Key (128 bits) | (IV) | (AN) | State |
| Null | Null | Null | Null |
| Null | Null | Null | Null |

For the key information table, the state field indicates whether the corresponding encryption parameter is used in the present or will be used in the next. If the parameter is used in the present, it is denoted as a current key CK. If the parameter will be used in the next, it is denoted as a next key NK. Here, if no secure channel is established between an OLT 11 and an ONU 12, and no key is distributed, all of the fields are set as an initial value of null.

The key information table in the initial state as shown in Table 1 is changed into a state as the following Table 2, when a secure channel has been established between the OLT 11 and the ONU 12 in the EPON system, a secure key having an association number (AN) of 2 has been distributed, and all the parameters have been transferred to the encryption module.

TABLE 2

| | Initialization Vector | Association Number | |
|---|---|---|---|
| Key (128 bits) | (IV) | (AN) | State |
| 0x | 0 x | 2 | CK |
| Null | Null | Null | Null |

In other words, a secure key value distributed to an entry is written in the key field of the key information table, the corresponding initialization vector value is written in the initialization vector (IV) field, two is written in the association number (AN) field, and CK is denoted as a state value to indicate that the key is used in the present.

Then, as available packet numbers (PN) are getting exhausted by transmitting or receiving frames through the secure channel, a new secure key having an association number of 3 to be used in the next is distributed between the OLT 11 and the ONU 12 according to a key distribution procedure. The key information table is changed as the following Table 3 when all the parameters have been transferred to the encryption module.

TABLE 3

| | Initialization Vector | Association Number | |
|---|---|---|---|
| Key (128 bits) | (IV) | (AN) | State |
| 0 x | 0 x | 2 | CK |
| 0 x | 0 x | 3 | NK |

That is, newly distributed key information such as a key value, an initialization vector value, and an association number is written in an empty entry, and NK is denoted in the state field of the entry.

Then, when the secure number is changed by exhausting all the packet numbers (PN) available for the currently used secure key, or a normal frame having an association number of 3 is received, the key information table is changed into a state as following Table 4.

TABLE 4

| | Initialization Vector | Association Number | |
|---|---|---|---|
| Key (128 bits) | (IV) | (AN) | State |
| Null | Null | Null | Null |
| 0 x | Ox | 3 | CK |

That is, since the use of the secure key of which the state value was denoted as CK has already expired, each of the field values, which are a key value, an initialization vector value, an association number, and a state value, for the entry is changed into an initial value of null, and then the state value of the entry is changed from CK to NK. According to the distribution of the new secure key and the change in the secure key, the key information table proposed in the present embodiment repeats the states as shown in Table 1 to Table 3.

The OLT 11 and the ONUs 12 transmit an encryption frame encrypted with the corresponding secure key through a secure channel in which the key information is managing in the key information table as mentioned above, or decode the received encryption frame with the corresponding secure key.

At that time, the receiving side checks whether the association number (AN) written in the secure tag of the frame has been changed or not in receiving the encryption frame.

If an encryption frame having different association number (AN) is received at step S110, the system determines whether the association number of the received frame is valid or not with reference to the key information table, at step S130.

More specifically, the system checks whether the association number extracted from the received frame has been written in the key information table, and whether the state of the secure key corresponding to the association number is CK or NK. For example, if the encryption frame having AN=3 is received in the state of the key information table as shown in Table 2, the received frame is determined as an attack frame since the association number of 3 is not written in the present key information table. In this case, this state is not a state that a secure key has been distributed and transferred to the encryption module, and therefore the receive frame may be the previously sent frame. On the contrary, if the encryption frame having AN=3 is received in the state as shown in Table 4, the received frame is determined as a normal frame.

By managing the key information table as described above, it is possible to check whether the received frame is a normal frame or not with no decrypting process, and to reduce DoS attack detection time by the frame decrypting time.

If the received encryption frame of which the association number has been changed is determined as a normal frame, the change of the secure key is performed, but otherwise, the secure key remains as it is, at steps S140 to S160.

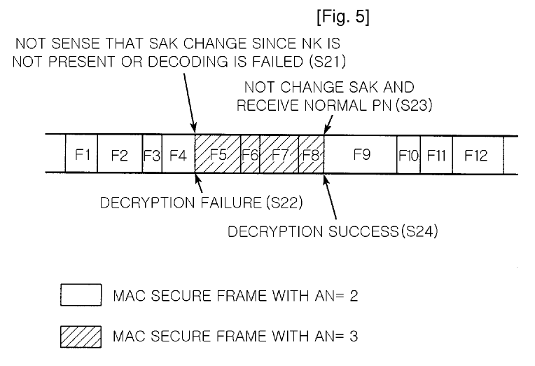

As shown in FIG. 5, while receiving the encryption frames F1 to F4 having AN=2, if attack frames F5 to F8 having AN=3 are received at step S21, the frames F5 to F8 can be recognized as attack frames by referring to the key information table according to the present invention, and the secure key is not changed. At this time, the decrypting of the attack frames F5 to F8 fails at step S22. After then, if a normal frame having AN=2 is received again at step S23, the received frame can be decoded normally since this state is a state in which the secure key having AN=2 is shared, at step S24.

### Mode for the Invention

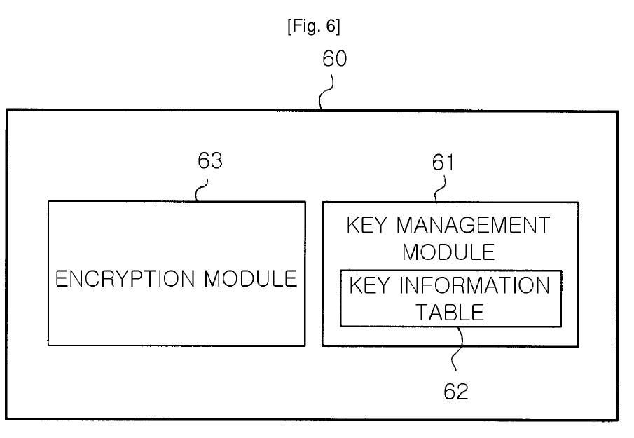

FIG. 6 is a functional block diagram illustrating an EPON secure channel control apparatus to which a key management method according to the present invention is applied.

The EPON secure channel control apparatus includes a key management module 61 for managing a key used in a secure channel and an encryption module 63 for performing the encrypting/decrypting of a frame to be transmitted/received using the key provided from the key management module 61.

The key management module 61 manages a key information table 62 as described above with reference to FIG. 4.

Here, the time of distributing a secure key between the OLT 11 and the ONU 12 by the key management module 61 may depend on the encryption module 63 or on its embedded timer. In the former case, when the encryption module 62 informs the key management module 61 of a packet number (PN) used for the currently transmitted or received frame, the key management module 61 compares the informed packet number (PN) with a predetermined threshold value. If the packet number (PN) reaches the threshold value, the key management module 61 distributes a new secure key and transfers it to the encryption module 63. Herein, it is preferable that the decision of the time to distribute a new secure key to the key management module 61 is made by a transmitting side that can know well the time to exhaust a packet number with no possible frame loss.

The key management module 61 may hold a new secure key, which will be in the next, to distribute between the OLT 11 and ONU 12 in advance, and transfer the new secure key to the encryption module 63 when the transferred packet number (PN) reaches the threshold value or immediately after the secure key is distributed. Like the former case, by waiting for the packet number to reach the threshold value and transferring the key to the encryption module, the time to detect DoS attack that occurs during the period from the time to distribute a current key to the time to transfer a next key can be reduced by the frame decryption time. Herein, the decision of the threshold value for the packet number (PN) is made by the key management module 61. It is preferable that the key management module 61 makes the decision of the time to distribute a key taking the time to spend to transfer the parameters of a new secure key to the encryption module 63 into consideration. Specifically, the time is set by subtracting the time to transfer a new secure key from the time to exhaust the packet number.

Also, when the key management module 61 depends on an embedded timer to make a key distribution decision, a timer is set according to the life time of an encryption key decided by a transmit rate of a link at the key management module 61 and the size of frame, and encryption keys can be regularly received at every times the timer ends, the encryption key is transferred to the encryption module 63. For example, at a link having a transmit rate of 1 Gbps, the encryption key is distributed once per every about 2³²/{1 Gbps/(64+24)*8} second.

### INDUSTRIAL APPLICABILITY

The present invention can be applied to manage a key required for encoding a frame in an Ethernet passive optical network, and more particularly, to the present invention can be applied to a key management method and a secure channel controller for preventing a key reuse attack among security attacks.

1. A key management method for providing a security service for an Ethernet passive optical network (EPON), the method comprising:
managing secure parameters including secure keys and their association numbers which are used in the present or will be used in the next by each secure channel by composing a key information table;
determining whether an association number of a received encryption frame is valid or not with reference to the key information table if the encryption frame of which association number has been changed is received; and
changing a secure key if the association number is determined to be valid, and not changing a secure key if the association number is not valid.

2. The key management method according to claim 1, wherein the key information table includes a field to write distributed secure key values, a field to write an initialization vector (IV) value used for an encryption algorithm corresponding to the secure key, a field to indicate an association number by which the secure key is used, and a state field to indicate whether the secure key is used in the present or will be used in the next.

3. The key management method according to claim 2, wherein in the step of managing secure parameters, an association number, and an initialization vector of the new secure key are written, and a state value is denoted as a current key to be used in the present in the state field if a new secure key is distributed in an initial state, and a key value, an association number, and an initialization vector of the new secure key are written, and a state value is denoted as a next key to be used in the next in the state field if a new secure key is distributed during an encryption service.

4. The key management method according to claim 3, wherein in the step of managing secure parameters, if a packet number available for the secure key is exhausted, or a normal encryption frame of which association number has been changed is received, an entry for which the state value has been denoted as the current key is deleted from the key information table, and a state value of an entry corresponding to the next key is changed into a current key.

5. The key management method according to claim 3, wherein in the step of determining whether an association number of a received encryption frame is valid or not, after an association number written in a secure tag of a received encryption frame is compared with an association number written as a parameter which will be used in the next in the key information table, the received encryption frame is determined to be valid if the two association numbers are identical to each other, otherwise, the received encryption frame is determined to be invalid if the two association numbers are not identical to each other.

6. The key management method according to claim 1, wherein after checking whether a packet number used in the secure key reaches a threshold value, the secure key is distributed when the packet number reaches the threshold value.

7. The key management method according to claim 6, wherein a transmitting side checks whether the packet number reaches the threshold value.

8. The key management method according to claim 1, wherein the distribution of the secure key is performed at an interval calculated in proportion to a link transfer rate and a frame size.

9. An apparatus for controlling a security channel in an EPON, the apparatus comprising:
a key management module for distributing a secure key used for a secure channel, composing a key information table, managing parameter information including the distributed secure key and its association number of each of the secure channel and a use state to indicate whether the corresponding parameter is used in the present or will be used in the next, and controlling a change in the secure key by determining whether an association number of a received frame is valid or not with reference to the key information table, if the association number of the received frame has been changed; and
an encryption module for encrypting/decrypting a transmitted/receive frame using a key provided from the key management module.

10. The apparatus of claim 9, wherein the key information table includes a field to write distributed secure key values, a field to write an initialization vector (IV) value used for an encryption algorithm corresponding to the secure key, a field to indicate an association number by which the secure key is used, and a state field to indicate whether the secure key is used in the present or will be used in the next.

11. The apparatus according to claim 10, wherein the key management module writes a key value, an association number, and an initialization vector of the new secure key and denotes a state value as a current key to be used in the present in the state field if a new secure key is distributed in an initial state, and the key management module writes a key value, an association number, and an initialization vector of the new secure key and denotes a state value as a next key to be used in the next in the state field if a new secure key is distributed during an encryption service.

12. The apparatus according to claim 11, wherein if a packet number available for the secure key is exhausted, or a normal encryption frame of which association number has been changed is received, the key management module deletes an entry for which the state value has been denoted as the current key from the key information table and changes a state value of an entry corresponding to the next key into a current key.

13. The apparatus according to claim 12, wherein after comparing an association number written in a secure tag of a received encryption frame with an association number written as a parameter which will be used in the next in the key information table, the key management module determines the received encryption frame to be valid if the two association numbers are identical to each other, and the key management module determines the received encryption frame to be invalid if the two association numbers are not identical to each other.

14. The apparatus according to claim 9, wherein after receiving information indicating whether a packet number used in the secure key reaches a threshold value, the key management module makes a decision of time to distribute a secure key based on the information.

15. The apparatus according to claim 14, wherein the decision of time to distribute the secure key is made by a transmitting side for the secure channel.

16. The apparatus according to claim 14, wherein the threshold value is set so as to transfer a newly distributed secure key and its parameter before a packet number is completely exhausted taking time to spend to transfer the distributed secure key and the parameter from the key management module to the encryption module into consideration.

17. The apparatus according to claim 9, wherein the key management module has an embedded timer that sets a time taking a link transfer rate, a transmitted/received frame size, and an available packet number into consideration and makes a decision of time to distribute a secure key in response to the timer operation.
